(19) United States
(12) Patent Application Publication
(10) Pub. No.: US 2016/0134115 A1
(43) Pub. Date: May 12, 2016

(54) ELECTRIC LOAD MANAGEMENT METHOD AND SYSTEM

(71) Applicant: INSTITUTE FOR INFORMATION INDUSTRY, TAIPEI CITY (TW)

(72) Inventors: SHEN-WEN CHEN, TAINAN CITY (TW); CHIA-SHIN YEN, TAIPEI CITY (TW)

(21) Appl. No.: 14/603,484

(22) Filed: Jan. 23, 2015

(30) Foreign Application Priority Data
Nov. 6, 2014 (TW) 103138563

(51) Int. Cl. H02J 3/14; G05B 13/02

(52) U.S. Cl. CPC H02J 3/14; G05B 13/021

(57) ABSTRACT

An electric load management method executed in an electric load management system of an aggregator is illustrated. A shedding request is received. Shedding users and shedding amounts thereof are obtained. Whether other shedding request in a history list exists is determined. When determining the other shedding request in a history list exists, a redundant shedding amount is calculated according to withdrawn probabilities and the shedding amounts of the shedding users, and a similar historical event of the shedding request is tried to be found among historical events. When the similar historical event of the shedding request exists, a virtual margin capacity is determined according to the redundant shedding amount and a requested total shedding amount of a power supply end and an actual total shedding amount of the shedding users in the similar historical event of the shedding request.

### BACKGROUND

1. Technical Field

The present disclosure relates to an electric load management method and system used in a power supply system; in particular, to the electric load management method and system for an aggregator, which calculates a virtual margin capacity, such that the probability that the requested total shedding amount of the power supply end is larger than the actual total shedding amount of the shedding users is decreased.

2. Description of Related Art

The electronic devices and appliances now are driven by electric power, and thus the power supply end, such as a power company, generates electric power by transducing thermal, nuclear, or tidal power, and provides the electric power to the power receiving end. The power generating cost usually is higher in rush hour than that in general hour, and now the government encourages the citizen and family to save the electric power and reduce the carbon emission. Thus, between the power receiving end and power supply end, there is an aggregator for negotiating the shedding users to participate in the shedding requests, so as to decrease the demand shedding amount of the electric power.

Furthermore, the aggregator and the power supply end have a specific contract therebetween, and the specific contract specifies that the aggregator can request the profit from the power supply end when the aggregator has achieved shedding requests (i.e. make the requested total shedding amount of the power supply end not larger than the actual total shedding amount of the shedding users). In addition, the aggregator and shedding users have also a specific contract therebetween, and the specific contract specifies that the shedding user can benefit cost-down electric power from the power supply end through the aggregator if the shedding user has participated in the shedding requests without dropping out the participated shedding requests (i.e. make the requested shedding amounts which the aggregator requests the shedding user respectively not larger than the actual shedding amounts of the shedding user).

However, after the aggregator may send the shedding request to the shedding request, the shedding user may participate in the shedding request, but then drop out the shedding event due to some cause. Thus, the requested total shedding amount of the power supply end is larger than the actual total shedding amount of the shedding users, i.e. the actual total shedding amount of the shedding users are not expectedly large. Accordingly, in the demand shedding amount negotiation, the aggregator must estimate a virtual margin capacity, add the virtual margin capacity with the requested total shedding amount of the power supply end, and use the adding result to negotiate with the shedding users and assign the shedding users to reach the needed shedding amounts, such that the actual total shedding amount of the shedding users can satisfy the requested total shedding amount of the power supply end.

U.S. Pub. 20120179596 A1 disclosed an electric load management method, which utilizes differences between expectation results and power receiving results of the shedding users to classify the shedding users, wherein the less the difference is, the higher the class of the shedding user is. The aggregator refers the classes of the shedding users to negotiate with the shedding users and assign the needed shedding amounts to the shedding users, wherein the higher the class of the shedding user is, the higher the probability for reaching the needed shedding amount is. In addition, the electric load management method can analyze the historical shedding amounts of the shedding users to evaluate risks, and then adjust the needed shedding amounts of the shedding users according to the evaluated risks. If the shedding amount of the shedding user is not expected, the class of the shedding user is lowered, and/or the shedding user may be charged with extra fees. However, the electric load management method still has high probability that the actual total shedding amount of the shedding users cannot reach the requested total shedding amount of the power supply end.

U.S. Pub. 20130268138 A1 disclosed another electric load management method, which sensing devices are installed in power receiving devices of the shedding users to estimate the total shedding amount. To put it concretely, through the sensing device, the characters related to the power receiving behaviors of the shedding users can be obtained, and the actual shedding amounts which the shedding users can achieve are estimated. The sensing devices transmit the sensing results to the administrator platform of the aggregator, and the administrator platform determines whether the shedding users are allowed to participate in the shedding request. However, the electric load management method must use many sensing devices, thus increasing hardware cost.

### SUMMARY

An exemplary embodiment of the present disclosure provides an electric load management method, executed in an electric load management system of an aggregator, comprising steps as follows. A shedding request is received. Shedding users and shedding amounts of the shedding users are obtained. Whether other shedding request in a history list exists is determined. When determining the other shedding request in a history list exists, a redundant shedding amount is calculated according to withdrawn probabilities and the shedding amounts of the shedding users, and a similar historical event of the shedding request is tried to be found among historical events. When the similar historical event of the shedding request exists, a virtual margin capacity is determined according to the redundant shedding amount and a requested total shedding amount of a power supply end and an actual total shedding amount of the shedding users in the similar historical event of the shedding request.

An exemplary embodiment of the present disclosure provides an electric load management system, comprising an information acquiring module, a history list determining module, a redundant shedding amount calculating module, a similar historical event searching module, a database, and a virtual margin capacity calculating module. The information acquiring module receives a shedding request, and obtains shedding users shedding amounts of the shedding users. The history list determining module is electrically connected to the information acquiring module, and determines whether other shedding request in a history list exists. The redundant shedding amount calculating module is electrically connected to the information acquiring module and the history list determining module. The similar historical event searching module is electrically connected to the information acquiring module and the history list determining module. The database is electrically connected to the history list determining module, the redundant shedding amount calculating module, and the similar historical event searching module. The virtual margin capacity calculating module is electrically connected to the history list determining module. When the history list determining module determines that the other shedding request in a history list exists, the redundant shedding amount calculating module calculates a redundant shedding amount according to withdrawn probabilities and the shedding amounts of the shedding users, and the similar historical event searching module tries to find a similar historical event of the shedding request among historical events in the database. When similar historical event searching module finds the similar historical event of the shedding request, the virtual margin capacity calculating module determines a virtual margin capacity according to the redundant shedding amount and a requested total shedding amount of a power supply end and an actual total shedding amount of the shedding users in the similar historical event of the shedding request.

To sum up, the electric load management method and system according to the exemplary embodiment of the present disclosure can decrease the probability that the actual total shedding amount cannot reach the requested total shedding amount of the power supply end.

In order to further understand the techniques, means and effects of the present disclosure, the following detailed descriptions and appended drawings are hereby referred, such that, through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a schematic diagram of a power supply system according to an exemplary embodiment of the present disclosure.

FIG. 2 is a block diagram of an electric load management system according to an exemplary embodiment of the present disclosure.

FIG. 3 is a flow chart of an electric load management method according to an exemplary embodiment of the present disclosure.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

An exemplary embodiment of the present disclosure provides an electric load management method and system, which is used by an aggregator. When receiving a shedding request of a power supply end, the electric load management method and system determines whether other shedding request in a history list exists, i.e. whether at least one previous shedding request of the power supply end is participated in or not. When the other shedding request in a history list does not exist, the electric load management method and system multiply the requested total shedding amount of the power supply end with a specific probability which is determined according to an empirical law, wherein the empirical law is a preset specific probability.

When the other shedding request in a history list exists, the electric load management method and system calculates a redundant shedding amount according to the shedding amounts and withdrawn probabilities of the shedding users. In one exemplary embodiment of the present disclosure, the shedding amounts of the shedding users are respectively multiplied by withdrawn probabilities of the shedding users to obtain individual redundant shedding amounts, and then the individual redundant shedding amounts are added to acquire the redundant shedding amount. Next, the electric load management method and system try to find a similar historical event of the shedding request. If the similar historical event of the shedding request cannot be found, the requested total shedding amount of the power supply end is multiplied by a specific probability determined according to an empirical law to get the virtual margin capacity.

If the electric load management method and system can find the similar historical event of the shedding request, the virtual margin capacity is determined according to the redundant shedding amount requested and the total shedding amount of the power supply end and the actual total shedding amount of the shedding users in the similar historical event of the shedding request. Next, the electric load management method and system adds the requested total shedding amount of the power supply end associated with the shedding request with the virtual margin capacity, and uses the adding result as the requested total shedding amount to the shedding users.

In short, the electric load management method and system can assign the shedding amounts to the shedding users according to the participating probabilities of the shedding users participating in the shedding request, and adjust the virtual margin capacity according to the actual condition. Thus, the electric load management method and system can decrease the probability that the actual total shedding amount cannot reach the requested total shedding amount of the power supply end, and have flexibility for assigning the shedding amounts to the shedding users. The following descriptions further depict detailed implementations of the electric load management method and system.

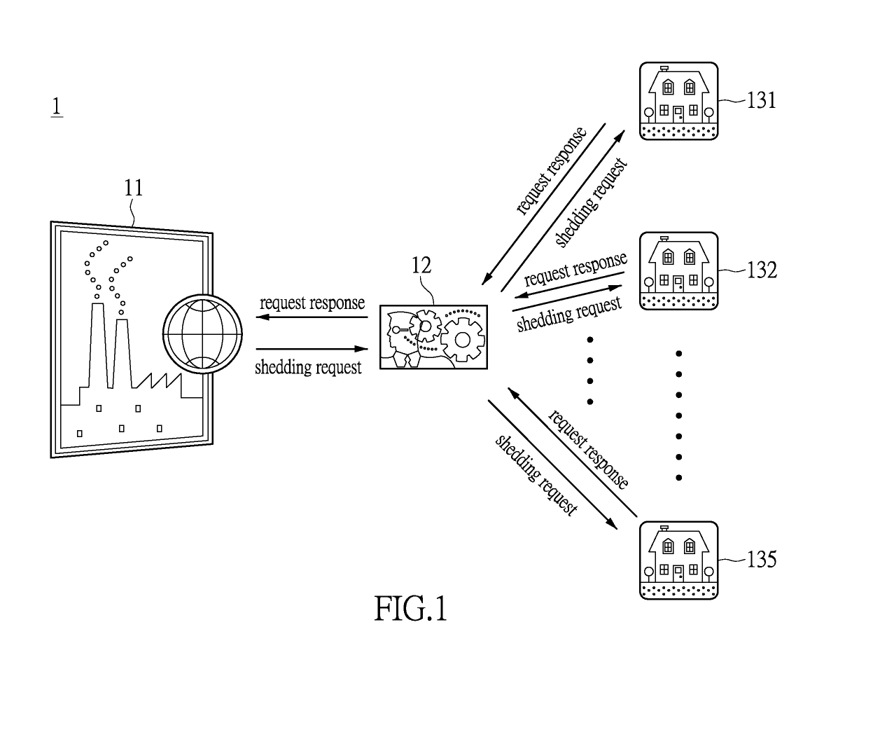

Referring to FIG. 1, FIG. 1 is a schematic diagram of a power supply system according to an exemplary embodiment of the present disclosure. The power supply system 1 comprises a power supply end 11, an aggregator 12, and shedding users 131-135, for example, 5 shedding user, but the present disclosure does not limit the number of the shedding users. The aggregator 12 can negotiate with the power supply end 11 and the shedding users 131-135 to determine the demand shedding amount, and the power supply end 11 supply the electric power to the shedding users 131-135 based on the negotiation result.

In rush hour, the power supply end 11 may transmit a shedding request to an aggregator 12 to diminish the massive power reception. After the aggregator 12 receives the shedding request from the power supply end 11, the aggregator 12 transmits shedding requests to the shedding users 131-135, and the shedding users 131-135 accordingly transmit the request responses to the aggregator 12 to indicate whether the shedding users can participate in the shedding requests of the aggregator 1. After the shedding users 131-135 transmit the request responses to the aggregator 12, the aggregator 12 accordingly transmit the request response to the power supply end 11 to indicate whether the aggregator 12 can achieve the shedding request of the power supply end 11.

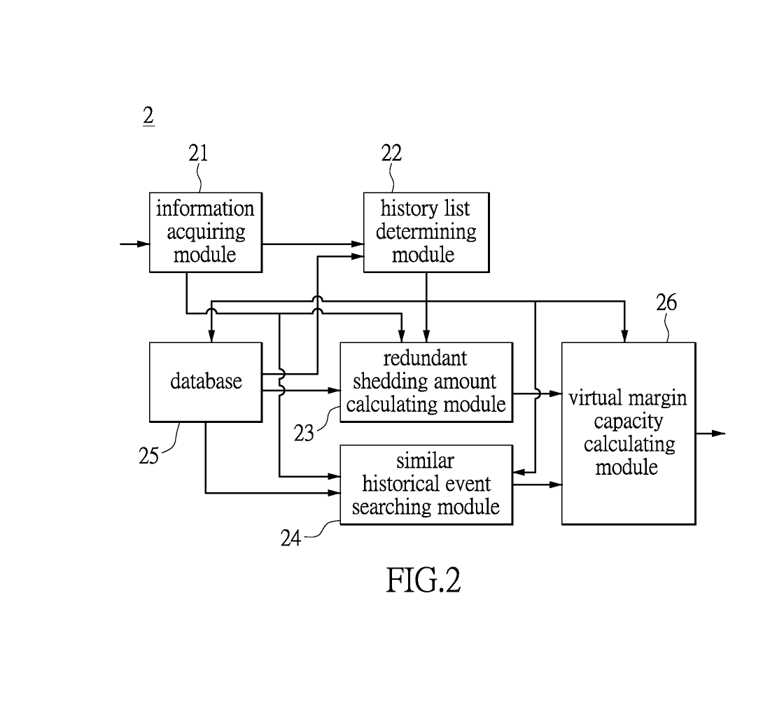

Referring to FIG. 2, FIG. 2 is a block diagram of an electric load management system according to an exemplary embodiment of the present disclosure. The electric load management system 2 is used by an aggregator, so as to calculate a virtual margin capacity. The electric load management system 2 comprises an information acquiring module 21, a history list determining module 22, a redundant shedding amount calculating module 23, a similar historical event searching module 24, a database 25, and a virtual margin capacity calculating module 26. The information acquiring module 21 is electrically connected to the history list determining module 22, the redundant shedding amount calculating module 23, and the similar historical event searching module 24. The history list determining module 22 is electrically connected to the database 25, the redundant shedding amount calculating module 23, the similar historical event searching module 24, and the virtual margin capacity calculating module 26. The database 25 is electrically connected to the redundant shedding amount calculating module 23 and the similar historical event searching module 24.

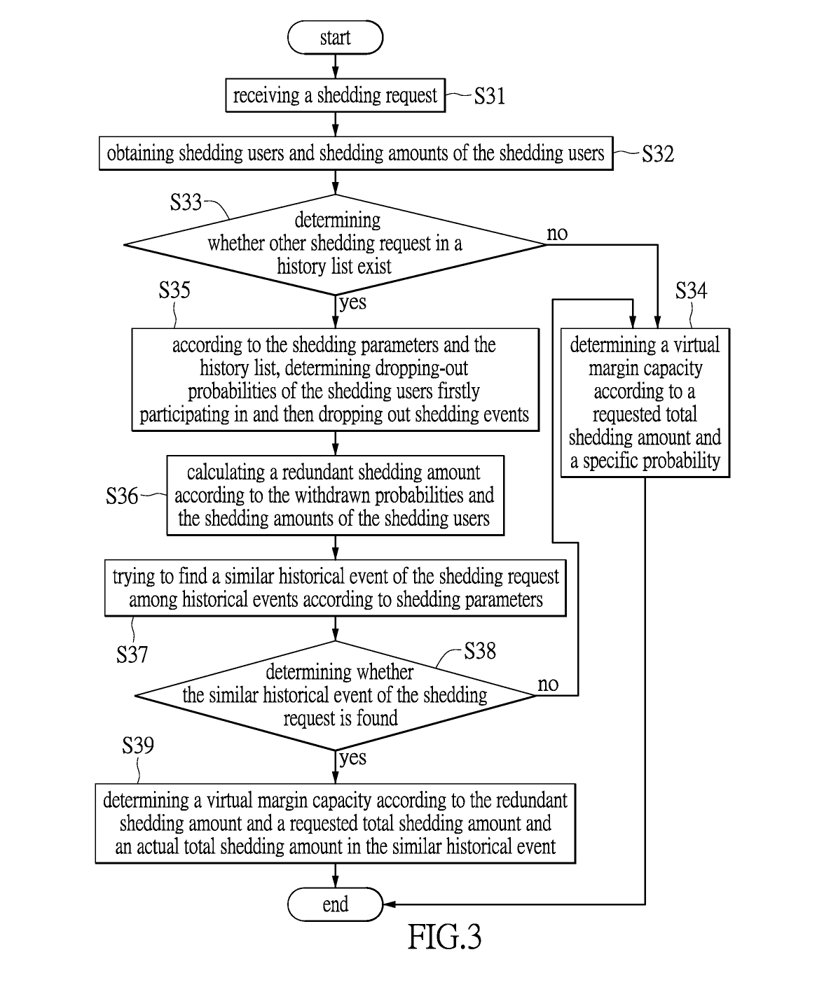

Referring to FIG. 2 and FIG. 3, FIG. 3 is a flow chart of an electric load management method according to an exemplary embodiment of the present disclosure. The electric load management method of FIG. 3 can be executed in the electric load management system 2, and the present disclosure does not limit the implementation of the electric load management system which can execute the electric load management method. Firstly, at step S31, the information acquiring module 21 receives a shedding request, wherein the shedding request comprises a requested total shedding amount of a power supply end.

Next, at step S32, the information acquiring module 21 can obtain shedding members among the users (i.e. obtain the shedding users), and obtain shedding amounts of the shedding users according to the requested total shedding amount of the power supply end, i.e. assign the shedding amounts to the shedding users according to the requested total shedding amount of the power supply end. For example, the requested total shedding amount of the power supply end is 1800 KW, and 5 users are shedding users respectively assigned with shedding mounts 100 KW, 300 KW, 500 KW, 300 KW, and 600 KW.

Next, at step S33, the history list determining module 22 determine whether at least one previous shedding request from the power supply end is received, i.e. determine whether other shedding request from the power supply end in a history list is used to perform negotiation and assignment of shedding users' shedding amounts. If the other shedding request in the history list does not exists, the history list determining module 22 generate a control signal to control the virtual margin capacity calculating module 26 to execute step S34. At step S34, since the other shedding request in the history list does not exists, the virtual margin capacity calculating module 26 determines the virtual margin capacity according to the requested total shedding amount of the power supply end and the specific probability, wherein the virtual margin capacity calculating module 26 multiplies the requested total shedding amount of the power supply end with the specific probability determined according to the empirical law to calculate the virtual margin capacity. For example, the requested total shedding amount of the power supply end is 1800 KW, the specific probability is 20%, and thus the virtual margin capacity is 360 KW (i.e. 1800 KW*20%).

If the other shedding request in the history list exists, the history list determining module 22 generates a control signal to control the database 25, the redundant shedding amount calculating module 23, and the similar historical event searching module 24 to further execute steps S35-S39. At step S35, since the other shedding request in the history list exists, the redundant shedding amount calculating module 23 finds a withdrawn probability of each shedding user for participating in the shedding request according to the shedding parameters and the history list from the database 25, and that is, the probability that each shedding user firstly participates in the shedding request and then drops out the shedding request due to some specific cause. It is noted that, the shedding parameter can be the shedding amount, shedding time length, shedding incentive (for example, cash return or benefit per shedding kilowatt hour, and the unit can be “dollar/kilowatt hour”), start shedding time, temperature, and/or other parameters related to the power receptions of the shedding users.

Next, at step S36, the redundant shedding amount calculating module 23 calculates the redundant shedding amount according to the shedding amounts and the withdrawn probabilities of the shedding users. To put it concretely, the shedding amount of each shedding user is multiplied by the withdrawn probability of the shedding user to obtain an individual redundant shedding amount, and a summation of the individual redundant shedding amounts is the redundant shedding amount. For example, 5 shedding users are found, their shedding amounts are respectively 100 KW, 300 KW, 500 KW, 300 KW and 600 KW, their withdrawn probabilities are respectively 10%, 8%, 15%, 5%, and 2%, and thus redundant shedding amount is 136 KW (100 KW*10%+300 KW*8%+500 KW*15%+300 KW*5%+600 KW*2%).

Next, at step S37, the similar historical event searching module 24 tries to find a similar historical event of the shedding request according to the shedding parameters from the database 25. At step S38, the similar historical event searching module 24 determines whether the similar historical event of the shedding request is found. If the similar historical event of the shedding request is found, the virtual margin capacity calculating module 26 is controlled to execute step S39. If the similar historical event of the shedding request is not found, the virtual margin capacity calculating module 26 is controlled to execute step S34. In addition, the manner for trying to find the similar historical event of the shedding request according to the shedding parameters is illustrated as follows, but the present disclosure is not limited thereto.

Firstly, the similar historical event searching module 24 calculates similar shedding amount ranges of the shedding users respectively according to the shedding amounts of the shedding users, wherein the similar shedding amount range of the shedding user can be a range formed between the shedding amount of the shedding user minus and plus the square root of the shedding amount associated with the shedding user, or alternatively, between the shedding amount of the shedding user minus and plus a range margin value which is calculated by the similar historical event searching module 24 according to the shedding amount of the shedding user. Next, for each shedding user, the similar historical event searching module 24 calculates a variance of each shedding parameter associated with the shedding user which historical shedding amounts recorded in the database 25 are fallen in the similar shedding amount. Then, the similar historical event searching module 24 calculates a normalized weighting value of each the shedding parameter according to the variances. To put it concretely, for each shedding parameter, the similar historical event searching module 24 calculates a summation reciprocal of variances of each shedding parameter of shedding users. Then, the similar historical event searching module 24 adds the summation reciprocals to obtain a total reciprocal, and the normalized weighting value of each shedding parameter is the corresponding summation reciprocal over the total reciprocal. Next, the similar historical event searching module 24 calculates the distances between the shedding request and the historical events in the database 25 by using the normalized weighting values, so as to find a historical event with a minimum distance as the similar historical event of the shedding request. It is noted that, if the minimum distance is still larger than a threshold distance, it means that the database 25 does not have the similar historical event of the shedding request, i.e. the similar historical event of the shedding request is not found among the historical events.

For example, the shedding amounts of the 5 shedding users are respectively 100 KW, 300 KW, 500 KW, 300 KW, and 600 KW, and their similar shedding amount ranges are 90-110 KW (100±\sqrt{100} KW), 283-317 KW (300±\sqrt{300} KW), 478-522 KW (500±\sqrt{500} KW), 283-317 KW (300±\sqrt{300} KW), and 576-624 KW (600±\sqrt{600} KW). If the variances of the shedding time length, shedding incentive, start shedding time, and the temperature of 5 shedding users which historical shedding amounts fall in their similar shedding amount rages are shown as TABLE I, the normalized weighting values of the shedding time length, shedding incentive, start shedding time, and the temperature are respectively p1=0.265 (W1/(W1+W2+W3+W4)), p2=0.371 (W2/(W1+W2+W3+W4)), p3=0.132 (W3/(W1+W2+W3+W4)), and p4=0.232 (W4/(W1+W2+W3+W4)).

TABLE I

| | shedding | | start | |
|---|---|---|---|---|
| | time | shedding | shedding | |
| variance | length | incentive | time | temperature |
| first | 0.3 | 0.1 | 0.7 | 0.2 |
| shedding user | | | | |
| second | 0.1 | 0.15 | 0.6 | 0.25 |
| shedding user | | | | |
| third | 0.5 | 0.2 | 0.7 | 0.35 |
| shedding user | | | | |
| fourth | 0.3 | 0.3 | 0.5 | 0.3 |
| shedding user | | | | |
| fifth | 0.2 | 0.25 | 0.3 | 0.5 |
| shedding user | | | | |
| summation of | 1.4 | 1 | 2.8 | 1.6 |
| variances | | | | |
| summation | W1 = 1/1.4 | W2 = 1/1 | W3 = 1/2.8 | W4 = 1/1.6 |
| reciprocal | | | | |

If the database 25 has first through third historical events, and the shedding parameters of the first through third historical events and the shedding request are shown as TABLE II, the distances between the first through third historical events and the shedding request are respectively 2.73 (\sqrt{(3−1)²·p1+(7−10)²·p2+(9−13)²·p3+(32−30)²·p4}), 1.96 (\sqrt{(3−3)²·p1+(7−5)²·p2+(9−13)²·p3+(32−31)²·p4}), and 1.69 (\sqrt{(3−2)²·p1+(7−6)²·p2+(9−10)²·p3+(32−29)²·p4}). Assuming the threshold distance is 2, the third historical events historical event is determined to be the similar historical event of the shedding request.

TABLE II

| | | shedding | start | |
|---|---|---|---|---|
| | shedding | incentive | shedding | temperature |
| shedding | time length | (dollar/kilo- | time | (Celsius |
| parameter | (hours) | watt hour) | (clock) | degree) |
| the shedding | 3 | 7 | 9 | 32 |
| request | | | | |
| first historical | 1 | 10 | 13 | 30 |
| event | | | | |
| second historical | 3 | 5 | 13 | 31 |
| event | | | | |
| third historical | 2 | 6 | 10 | 29 |
| event | | | | |

Next, at step S39, the virtual margin capacity calculating module 26 determines the virtual margin capacity according to the redundant shedding amount and a requested total shedding amount of a power supply end and an actual total shedding amount of the shedding users in the similar historical event of the shedding request. After determining the virtual margin capacity, the electric load management system 2 can add the virtual margin capacity and the requested total shedding amount of the power supply end of the shedding request, and use the adding result to negotiate with the shedding users and assign the shedding amounts to the shedding users. The details for determining the virtual margin capacity is depicted as follows, but the present disclosure is not limited thereto.

In the similar historical event, if the requested total shedding amount of the power supply end is larger than the actual total shedding amount of the shedding users, the virtual margin capacity is determined according to the redundant shedding amount and a differential value of the requested total shedding amount of the power supply end minus the actual total shedding amount of the shedding users, wherein the virtual margin capacity is larger than the differential value, for example, the virtual margin capacity is the summation of the differential value and the redundant shedding amount.

In the similar historical event, if the requested total shedding amount of the power supply end is less than or equal to the actual total shedding amount of the shedding users, the virtual margin capacity is determined according to the redundant shedding amount and the differential value of the actual total shedding amount of the shedding users minus the requested total shedding amount of the power supply end, wherein the virtual margin capacity is less than the differential value, for example, the virtual margin capacity is an average of the differential value and the redundant shedding amount.

For example, if the redundant shedding amount is 136 KW, and in the similar historical event, the requested total shedding amount of the power supply end and the actual total shedding amount of the shedding users are respectively 1800 KW and 1500 KW, the virtual margin capacity can be 436 KW ((1800−1500)+136 KW). if the redundant shedding amount is 136 KW, and in the similar historical event, the requested total shedding amount of the power supply end and the actual total shedding amount of the shedding users are respectively 1350 KW and 1800 KW, the virtual margin capacity can be 293 KW (((1800−1350)+136 KW)/2).

To sum up, the electric load management method and system provided by exemplary embodiments can assign the shedding amounts to the shedding users according to the participating probabilities of the shedding users participating in the shedding request, and adjust the virtual margin capacity according to the actual condition. Thus, the electric load management method and system can decrease the probability that the actual total shedding amount cannot reach the requested total shedding amount of the power supply end, and have flexibility for assigning the shedding amounts to the shedding users.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. An electric load management method, executed in an electric load management system of an aggregator, comprising:
receiving a shedding request;
obtaining shedding users and shedding amounts of the shedding users;
determining whether other shedding request in a history list exists;
when determining the other shedding request in a history list exists, calculating a redundant shedding amount according to withdrawn probabilities and the shedding amounts of the shedding users, and trying to find a similar historical event of the shedding request among historical events;
when the similar historical event of the shedding request exists, determining a virtual margin capacity according to the redundant shedding amount and a requested total shedding amount of a power supply end and an actual total shedding amount of the shedding users in the similar historical event.

2. The electric load management method according to claim 1, further comprising:
when the other shedding request in the history list or the similar historical event of the shedding request does not exist, determining the virtual margin capacity according to a requested total shedding amount of the power supply end associated with the shedding request and a specific probability.

3. The electric load management method according to claim 1, further comprising:
determining the withdrawn probabilities of the shedding users according to the shedding parameters and the history list.

4. The electric load management method according to claim 1, wherein the withdrawn probabilities of the shedding users are multiplied with the shedding amounts of the shedding users to obtain individual redundant shedding amounts, and the redundant shedding amount is a summation of the individual redundant shedding amounts.

5. The electric load management method according to claim 1, wherein the step for trying to find the similar historical event of the shedding request comprises:
calculating similar shedding amount ranges of the shedding users respectively according to the shedding amounts of the shedding users;
for each of the shedding users, calculating a variance of each shedding parameter associated with the shedding user which historical shedding amounts recorded in a database are fallen in the similar shedding amount;
calculating a normalized weighting value of each shedding parameter according to the variances;
calculating distances between the shedding request and the historical events in the database by using the normalized weighting values, so as to find the historical event with a minimum distance as the similar historical event of the shedding request.

6. The electric load management method according to claim 1, wherein in the similar historical event, if the requested total shedding amount of the power supply end is larger than the actual total shedding amount of the shedding users, the virtual margin capacity is determined according to the redundant shedding amount and a differential value of the requested total shedding amount of the power supply end minus the actual total shedding amount of the shedding users, wherein the virtual margin capacity is larger than the differential value.

7. The electric load management method according to claim 6, wherein the virtual margin capacity is a summation of the differential value and the redundant shedding amount.

8. The electric load management method according to claim 1, wherein the similar historical event, if the requested total shedding amount of the power supply end is less than or equal to the actual total shedding amount of the shedding users, the virtual margin capacity is determined according to the redundant shedding amount and the differential value of the actual total shedding amount of the shedding users minus the requested total shedding amount of the power supply end, wherein the virtual margin capacity is less than the differential value.

9. The electric load management method according to claim 8, wherein the virtual margin capacity is an average of the differential value and the redundant shedding amount.

10. An electric load management system, comprising:
an information acquiring module, used to receive a shedding request, and obtaining shedding users and shedding amounts of the shedding users;
a history list determining module, electrically connected to the information acquiring module, used to determine whether other shedding request in a history list exist;
a redundant shedding amount calculating module, electrically connected to the information acquiring module and the history list determining module;
a similar historical event searching module, electrically connected to the information acquiring module and the history list determining module;
a database, electrically connected to the history list determining module, the redundant shedding amount calculating module, and the similar historical event searching module; and
a virtual margin capacity calculating module, electrically connected to the history list determining module;
wherein when the history list determining module determines the other shedding request in a history list exists, the redundant shedding amount calculating module calculates a redundant shedding amount according to withdrawn probabilities and the shedding amounts of the shedding users, and the similar historical event searching module tries to find a similar historical event of the shedding request among historical events; if the similar historical event searching module finds the similar historical event, the virtual margin capacity calculating module determines a virtual margin capacity according to the redundant shedding amount and a requested total shedding amount of a power supply end and an actual total shedding amount of the shedding users in the similar historical event of the shedding request.

11. The electric load management system according to claim 10, wherein if the history list determining module determines the other shedding request in the history list or the similar historical event of the shedding request does not exist, the virtual margin capacity calculating module determines the virtual margin capacity according to a requested total shedding amount of the power supply end associated with the shedding request and a specific probability.

12. The electric load management system according to claim 10, wherein the redundant shedding amount calculating module determines the withdrawn probabilities of the shedding users according to the shedding parameters and the history list from the database.

13. The electric load management system according to claim 10, wherein the redundant shedding amount calculating module multiplies the withdrawn probabilities of the shedding users with the shedding amounts of the shedding users to obtain individual redundant shedding amounts, and adds the individual redundant shedding amounts to obtain the redundant shedding amount.

14. The electric load management system according to claim 10, wherein the similar historical event searching module calculates similar shedding amount ranges of the shedding users respectively according to the shedding amounts of the shedding users; for each of the shedding users, the similar historical event searching module calculates a variance of each shedding parameter associated with the shedding user which historical shedding amounts recorded in the database are fallen in the similar shedding amount; the similar historical event searching module calculates a normalized weighting value of each shedding parameter according to the variances; the similar historical event searching module calculates distances between the shedding request and the historical events in the database by using the normalized weighting values, so as to find the historical event with a minimum distance as the similar historical event of the shedding request.

15. The electric load management system according to claim 10, in the similar historical event, if the requested total shedding amount of the power supply end is larger than the actual total shedding amount of the shedding users, the virtual margin capacity is determined according to the redundant shedding amount and a differential value of the requested total shedding amount of the power supply end minus the actual total shedding amount of the shedding users, wherein the virtual margin capacity is larger than the differential value.

16. The electric load management system according to claim 15, wherein the virtual margin capacity is a summation of the differential value and the redundant shedding amount.

17. The electric load management system according to claim 10, wherein the similar historical event, if the requested total shedding amount of the power supply end is less than or equal to the actual total shedding amount of the shedding users, the virtual margin capacity is determined according to the redundant shedding amount and the differential value of the actual total shedding amount of the shedding users minus the requested total shedding amount of the power supply end, wherein the virtual margin capacity is less than the differential value.

18. The electric load management system according to claim 17, wherein the virtual margin capacity is an average of the differential value and the redundant shedding amount.
